(19) United States
(12) Patent Application Publication
(10) Pub. No.: US 2026/0302442 A1
(43) Pub. Date: Oct. 1, 2026

(54) Pouch For Secondary Battery And Lithium Secondary Battery Comprising The Same

(71) Applicant: LG Energy Solution, Ltd., Seoul (KR)

(72) Inventors: Min Hyuk Yun, Daejeon (KR); Duck Hoe Kim, Daejeon (KR); In Yong Baek, Daejeon (KR); Ji Young Hwang, Daejeon (KR); Jeong Hyeon Park, Daejeon (KR); Wan Gyeong Jang, Daejeon (KR); Dae Woong Song, Daejeon (KR); Moo Yeon Kim, Daejeon (KR)

(73) Assignee: LG Energy Solution, Ltd., Seoul (KR)

(21) Appl. No.: 19/701,080

(22) Filed: Jun. 8, 2026

Related U.S. Application Data
(63) Continuation of application No. 18/545,407, filed on Dec. 19, 2023.

(30) Foreign Application Priority Data
Dec. 23, 2022 (KR) 10-2022-0183748

(51) Int. Cl. H01M 50/129; H01M 10/04; H01M 10/052; H01M 50/105; H01M 50/119; H01M 50/121; H01M 50/133

(52) U.S. Cl. CPC H01M 50/129; H01M 10/0431; H01M 10/052; H01M 50/105; H01M 50/119; H01M 50/121; H01M 50/133

(57) ABSTRACT

Provided is a pouch for a secondary battery and a lithium secondary battery including the same. The pouch for the secondary battery includes a barrier layer, a base material layer disposed on one surface of the barrier layer, and a sealant layer disposed on the other surface of the barrier layer. The sealant layer includes a first sealant layer disposed on directly in contact with the other surface of the barrier layer, and a second sealant layer disposed on the first sealant layer. The sealant layer has a melt flow rate (MFR) of about 14.0 g/10 min or less, which is measured at a temperature of about 230° C. under a load condition of about 2.16 kg.

### CROSS-REFERENCE TO RELATED APPLICATIONS

This application is a continuation of U.S. application Ser. No. 18/545,407, filed on Dec. 19, 2023 which claims priority to Korean Patent Application No. 10-2022-0183748 filed on Dec. 23, 2022, in the Korean Intellectual Property Office, the disclosure of which is incorporated herein by reference.

### BACKGROUND

### Technical Field

The present disclosure generally relates to a pouch for a secondary battery and a lithium secondary battery including the same. More particularly, the present disclosure relates to a pouch for a secondary battery with high cell vent resistance, low vent generation, and exhibits excellent high-temperature reliability, and a lithium secondary battery including the same.

### Description of the Related Art

Lithium secondary batteries are often manufactured by applying electrode active material slurry to positive electrode collectors and negative electrode collectors to manufacture positive electrodes and negative electrodes. The positive electrodes and the negative electrodes are then stacked on both sides of a separator to form an electrode assembly. Next, the electrode assembly is accommodated in a case, and an electrolyte is injected into the case.

Traditionally, secondary batteries have been classified according to a shape of the case accommodating the electrode assembly. Example secondary batteries include pouch-type secondary batteries, can-type secondary batteries, and prismatic-type secondary batteries. For example, pouch-type secondary batteries are manufactured by pressing a flexible pouch film stack to form a cup part, into which an electrode assembly is accommodated, before an electrolyte is injected and a sealing part of the case is sealed. Can-type secondary batteries, on the other hand, are manufactured by accommodating an electrode assembly in a can made of a metal material, injecting an electrolyte into the can, and fastening a top cap onto an upper portion of the can to seal the electrode assembly and the electrolyte.

While pouch-type secondary batteries are light weight, exhibit excellent space utilization, and have high energy densities, due to their stacked electrode assemblies, pouch-type secondary batteries are more vulnerable to fire, explosion, and electrolyte leakage upon external impact and/or high internal temperatures or pressure compared to can-type secondary batteries.

Secondary batteries and particularly, pouch-type secondary batteries, are used in a wide variety of products including electric vehicles to reduce and/or prevent greenhouse gas emission. When secondary batteries are used to power electric vehicles, the batteries are required to have excellent safety to protect the vehicle's passengers. Therefore, there is a desire to develop a pouch-type secondary battery having high cell vent resistance and low vent generation in high-temperature environments so that the secondary battery is reliable at high-temperatures.

### SUMMARY

An aspect of the present disclosure provides a pouch having a specific melt flow rate, including a sealant layer having a two-layer structure, having high cell vent resistance, and having excellent high-temperature reliability, and a lithium secondary battery including the same.

According to an aspect of the present disclosure, a pouch for a secondary battery includes: a barrier layer; a base material layer disposed on one surface of the barrier layer; and a sealant layer disposed on the other surface of the barrier layer. The sealant layer includes: a first sealant layer disposed directly in contact with the other surface of the barrier layer; and a second sealant layer disposed on the first sealant layer, and the sealant layer has a melt flow rate (MFR) of about 14.0 g/10 min or less, which is measured at a temperature of about 230° C. under a load condition of about 2.16 kg. In some instances, the MFR may be about 8.5 g/10 min to about 14.0 g/10 min,

The first sealant layer and the second sealant layer may have a co-extruded structure.

The first sealant layer may include an acid-modified polyolefin resin, and the second sealant layer may include a polyolefin resin.

A thickness ratio of the second sealant layer to the thickness of the first sealant layer may be about 0.8 to about 1.2, preferably about 0.9 to about 1.1. The first sealant layer may have a thickness of about 25 μm to about 80 μm, preferably about 30 μm to about 70 μm, and more preferably about 30 μm to about 60 μm, and the second sealant layer may have a thickness of about 20 μm to about 80 μm, preferably about 25 μm to about 70 μm, and more preferably about 30 μm to about 60 μm.

The total thickness of the sealant layer (e.g., the combination of the first sealant layer and the second sealant layer) may be about 45 μm to about 100 μm, preferably about 50 μm to about 100 μm, more preferably about 60 μm to about 100 μm, and even more preferably about 70 μm to about 90 μm.

The barrier layer may include an aluminum alloy layer.

The base material layer may include polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazoles, polyarylates, or Teflon.

According to another aspect of the present disclosure, a lithium secondary battery includes: an electrode assembly, in which a positive electrode, a separator, and a negative electrode are stacked; an electrolyte; and the above-described pouch.

In the lithium secondary battery, cell vent resistance may be about 7.7 bars or more, preferably about 7.7 bars to 15 bars, and more preferably about 8 bars to about 15 bars at a temperature of about 60° C.

An accelerated high-temperature storage period, which is measured by charging the lithium secondary battery up to SOC 100% at a temperature of about 70° C. for 1-day intervals, may be about 15 days or more, preferably about 15 days to about 30 days, and more preferably about 15 days to about 25 days.

According to yet another aspect of the present disclosure, a method of forming a pouch for a secondary battery, includes the steps of: stacking a base material layer on a first surface of a barrier layer; and co-extruding a sealant layer, including a first sealant layer and a second sealant layer, on a second surface of the barrier layer, wherein the sealant layer has a melt flow rate (MFR) of about 14.0 g/10 min or less, which is measured at a temperature of about 230° C. under a load condition of about 2.16 kg.

After the co-extruding step, the first sealant layer may be in direct contact with the barrier layer, and the second sealant layer may be stacked on a surface of the first sealant layer.

The first sealant layer may include an acid-modified polyolefin resin, and the second sealant layer may include a polyolefin resin.

The resin pressure may be controlled, using a co-extrusion device, during the co-extruding step.

The co-extruding step may include replacing a filter of the co-extrusion device when the resin pressure exceeds a predetermined value to control the resin pressure.

The sealant layer may be co-extruded to have thickness in a range of about 45 μm to about 100 μm, such that, the first sealant layer may have a thickness of about 25 μm to about 80 μm, and the second sealant layer may have a thickness of about 20 μm to about 80 μm.

### BRIEF DESCRIPTION OF THE DRAWINGS

Aspects, features and other advantages of the present disclosure will be more clearly understood from the following detailed description taken in conjunction with the accompanying drawings, in which:

FIG. 1 is a cross-sectional view of a pouch film stack according to an embodiment of the present invention.

FIG. 2 is an exploded perspective view of a secondary battery according to another embodiment of the present invention.

FIG. 3 is a graph showing results obtained by measuring cell vent resistance and an accelerated high-temperature storage period according to an Embodiment of the present disclosure and a Comparative Example.

### DETAILED DESCRIPTION OF THE PREFERRED EMBODIMENT

As a result of repeated research to develop a pouch-type secondary battery having excellent high-temperature reliability, the present inventors found that when a melt flow index of a sealant layer of a pouch satisfies a specific range, the sealing strength of the sealant layer (cell vent resistance) is drastically improved even as pressure inside the cell increases. As a result, the sealant layer suppresses a vent from occurring even at high-temperatures, thereby significantly improving the seal and reliability of the secondary battery.

### Pouch

A pouch according to the present disclosure includes a barrier layer, a base material layer disposed on an outer surface of the barrier layer, and a sealant layer disposed on an inner surface of the barrier layer. The sealant layer may include a first sealant layer disposed on the inner surface of the barrier layer and a second sealant layer disposed on the first sealant layer. The sealant layer as a whole (e.g., the combination of the first and second sealant layers), has a melt flow rate (MFR) of about 14.0 g/10 min or less, preferably, about 8.5 g/10 min to about 14.0 g/10 min, and more preferably about 9.0 g/10 min to about 13.5 g/10 min, when measured at a temperature of about 230° C. under a load condition of about 2.16 kg.

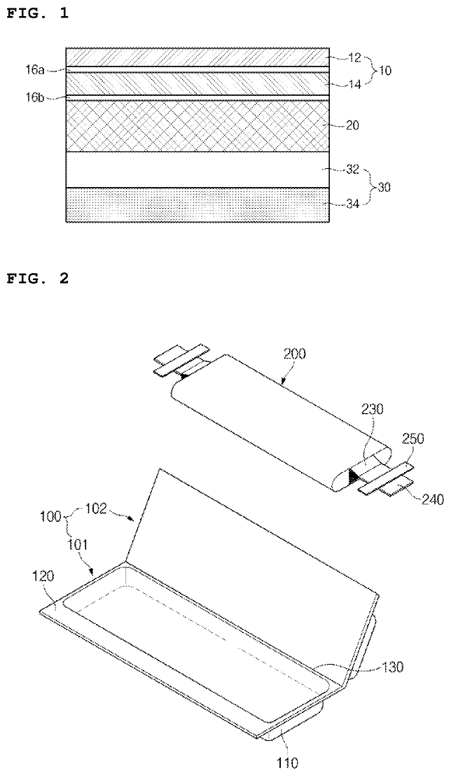

FIG. 1 is a cross-sectional view of a pouch film stack according to an embodiment of the present disclosure. FIG. 2 is an exploded perspective view of a secondary battery according to an embodiment of the present disclosure. The secondary battery includes including a pouch 100 for accommodating an electrode assembly 200 and an electrolyte.

The pouch film stack may include a barrier layer 20, a base material layer 10 disposed on the outer surface of the barrier layer, and a sealant layer 30 disposed on the inner surface of the barrier layer.

The pouch 100 includes a first case 101 and a second case 102 and may be manufactured by molding the pouch film stack. For example, the pouch 100 may be manufactured by inserting the pouch film stack into a press molding device, and applying a pressure to the pouch film stack to stretch the stack and form a recessed cup part in at least one of the first case 101 and/or the second case 102.

### Sealant Layer

The sealant layer 30 of the first case 101 and the sealant layer 30 of the second case may be configured to seal the pouch when the sealant layers of the first and second cases are bonded together through thermal compression.

The sealant layer 30 may have a two-layer structure, and more specifically, may include a first sealant layer 32 and a second sealant layer 34. The first sealant layer 32 may be disposed so that one surface thereof is in direct contact with the barrier layer 20, and the second sealant layer 34 is disposed at an opposite surface of the first sealant layer 32 (e.g., a surface not in contact with the barrier layer 20).

The first sealant layer 32 and the second sealant layer 34 may be formed by co-extruding a resin constituting the first sealant layer and a resin constituting the second sealant layer on the barrier layer 20.

Alternatively, the sealant layer may be stacked on the barrier layer using a dry lamination process, in which the sealant layer is attached to the barrier layer using a thermosetting adhesive. However, when the sealant layer is formed using the co-extrusion process, the sealant layer is formed to have a greater melt flow rate than when the sealant layer is formed using the dry lamination, which in turn, expedites a subsequent sealing process is and simplifies manufacturing of the secondary battery.

In addition, when a thermosetting adhesive is not used to attach the sealant layer 30 to the barrier layer 20 (as is the case in the dry lamination process), the pouch 100 is formed to have excellent moisture resistance and high-temperature durability.

The first sealant layer 32 and the second sealant layer 34 may have different compositions. Specifically, the first sealant layer 32 may include an acid-modified polyolefin resin, and the second sealant layer 34 may include a polyolefin resin. When the first sealant layer 32 is made of the acid-modified polyolefin resin, and the second sealant layer 34 is made of the polyolefin resin, adhesion with the barrier layer 20 and high temperature sealing strength may be improved.

Since the sealant layer 30 is a surface that is in contact with the electrolyte and electrode assembly 200 after the pouch is molded, the sealant layer 30 is preferably formed from materials having insulation and corrosion resistance. Also, since the sealant layer 30 has to be completely sealed to prevent the leakage of electrolyte, the sealant layer 30 may be formed from a material having high sealability. Polyolefin resin is an example of material that has desirable mechanical properties for performing the above-described functions. For example, polyolefin resin has high tensile strength, rigidity, surface hardness, abrasion resistance, and heat resistance, and chemical properties such as corrosion resistance and thus is a suitable material for the sealant layer. However, because polyolefin resins do not typically adhere thoroughly with certain materials such as aluminum alloys (constituting the barrier layer 20), when the sealant layer is made only of polyolefin resin, interfacial peeling may occur between the barrier layer 20 and the sealant layer 30 when the battery is exposed to high temperatures or high internal pressures. Therefore, an acid-modified polyolefin resin, into which an acid component is introduced into the polyolefin resin, may be used utilized to construct the first sealant layer 32 to improve the adhesion of the first sealant layer 32 with the barrier layer 20, and to improve the above-described mechanical and chemical properties of the sealant layer 30. When the sealant layer is not formed in two layers, but is formed in a single layer made of the acid-modified polyolefin resin, the chemical resistance and mechanical properties may not be as desirable, and may result in a decrease in sealing strength. Similarly, when the sealant layer is formed in a single layer made of the polyolefin resin, adhesion between the sealant layer 30 and the barrier layer 20 is reduced, and result in a vent occurring at an interface between the sealant layer 30 and the barrier layer 20 when exposed to high temperature.

The acid-modified polyolefin resin may be a polymer modified by block polymerization or graft polymerization of polyolefin with an acid component, for example, a polymer obtained by polymerizing a carboxylic acid such as acrylic acid, methacrylic acid, maleic acid, itaconic acid, crotonic acid, maleic anhydride, itaconic anhydride or the like, or an anhydride thereof in polyolefin.

The polyolefin, for example, may be a polyethylene such as low density polyethylene, medium density polyethylene, high density polyethylene, linear low density polyethylene, etc.; ethylene-xx olefin copolymers; polypropylenes such as homopolypropylene, block copolymers of polypropylene (for example, block copolymers of propylene and ethylene), and random copolymers of polypropylene (for example, random copolymers of propylene and ethylene); propylene-α olefin copolymer; ethylene-butene-propylene trimer, or the like, but is not limited thereto.

The sealant layer has a melt flow rate (MFR) of about 14.0 g/10 min or less, and preferably, about 8.5 g/10 min to about 8.5 g/10 min, which is measured at a temperature of about 230° C. under a load condition of about 2.16 kg. When the melt flow rate of the sealant layer exceeds about 14.0 g/10 min, resistance to an internal pressure of the battery is significantly reduced and, as a result, venting may occur when the battery is exposed to high temperatures. That is, when the melt flow rate of the sealing layer exceeds about 14.0 g/10 min, the cell vent resistance is significantly reduced. Here, the cell vent resistance means a maximum pressure at which a vent does not occur when a gas is injected into the cell. Thus, the higher the cell vent resistance, the better the high temperature reliability.

The melt flow rate of the sealant layer means a melt flow rate of the entire sealant layer including the first sealant layer and the second sealant layer and is a value different from the melt flow rate of each of the first sealant layer and the second sealant layer. In addition, the melt flow rate of the sealant layer is a value measured after co-extrusion. The safety of lithium secondary batteries is affected by the physical properties of the sealant layer after co-extrusion, so the melt flow rate after co-extrusion is important. Since the melt flow rate of the thermoplastic resin varies depending on conditions during the co-extrusion process, the melt flow rate after the co-extrusion is often a different value than a value derived by simply arithmetically calculating a melt flow rate of a raw material before extrusion.

The melt flow rate of the sealant layer may be measured through the following method.

First, the pouch is cut into a size of about 50 mm×300 mm, put in hydrochloric acid having a concentration of about 37% by weight, and left therein for a period of about 3 hours to about 48 hours to melt the aluminum of barrier layer 20 and to separate the sealant layer in the form of a film. Then, after sufficiently rinsing the film with water, the sealant layer is dried at a temperature of about 60° C. for a period of about 2 hours or more. The separated sealant layer, in the form of the film, is then rolled into a cylindrical shape to prepare a sample. Three prepared samples were put into a measuring device (Gottfert MI-40) and melted at a temperature of about 230° C. for about 5 minutes, and then, the melt flow rate value is measured through a melt volume rate (MVR) method while applying a load of about 2.16 kg. It is assumed that a melt density of the sealant layer is about 0.728 g/cm³, and a volume is converted into a mass to obtain the melt flow rate.

When the sealant layer has a two-layer structure formed through the co-extrusion, the physical properties such as the melting point and the melt flow rate are different than a sealant layer having a single layer structure because the composition of the first sealant layer and the second sealant layer are different. Due to the difference in physical properties of the materials, and the thickness of the first sealant layer and the second sealant layer, the melt flow rate of the entire sealant layer may vary. Again, when the melt flow rate of the entire sealant layer exceeds about 14.0 g/10 min, peeling may occur at the interface between the sealant layer and the barrier layer, which may cause a vent when the battery is exposed to the high temperature, or high internal pressure. As a result of repeated research to solve this limitation, the inventors of the present disclosure have found that the melt flow rate of the entire sealant layer including the first sealant layer and the second sealant layer may be altered by controlling a pressure that is applied to a filter of the co-extrusion device (hereinafter, referred to as ‘resin pressure’) during the co-extrusion process. When the melt flow rate of the entire sealant layer is controlled within a specific range of about 14.0 g/10 min or less, through the resin pressure control, the interfacial peeling between the sealant layer and the barrier layer is suppressed, resulting in a significant improvement in resistance e to the internal pressure of the battery (e.g., cell vent resistance).

The resin pressure increases as the number of times of co-extrusion of the resin increases. Thus, the pressure applied to the filter of the co-extrusion device may be monitored over time, and the resin pressure may be controlled by replacing the filter when the resin pressure exceeds a set range. The range of resin pressure for forming the sealant layer having a desired melt flow rate may vary according to the types of resins constituting the first sealant layer and the second sealant layer, the thicknesses of the first sealant layer and the second sealant layer, and the types of co-extrusion devices. Armed with this knowledge, a person skilled in the art will be able to derive a resin pressure range so that the melt flow rate of the sealant layer is about 14.0 g/10 min or less through ordinary experiments.

A ratio of the thickness of second sealant layer to the thickness of the first sealant layer may be about 0.8 to about 1.2, and preferably about 0.9 to about 1.1. When the ratio of the thickness of the second sealant layer to the thickness of the first sealant layer satisfies the above range, the sealant layer has excellent adhesion to the barrier layer, and the pouch has excellent insulation and sealing strength. If one of the first sealant layer and the second sealant layer is too thick or too thin, the resin constituting the sealant layer may flow out during sealing, or the adhesion and sealing performance between the sealant layer and the barrier layer may be deteriorated.

More particularly, the first sealant layer may have a thickness of about 25 μm to about 80 μm, preferably about 30 μm to about 70 μm, and more preferably about 30 μm to about 60 μm. When the thickness of the first sealant layer satisfies the above range, the adhesion with the barrier layer is excellent.

The second sealant layer may have a thickness of about 20 μm to about 80 μm, preferably about 25 μm to about 70 μm, and more preferably about 30 μm to about 60 μm. When the thickness of the second sealant layer satisfies the above range, the sealing performance is excellent.

The total thickness of the sealant layer (the combination of the first sealant layer and the second sealant layer) may be about 45 μm to about 100 μm, preferably about 50 μm to about 100 μm, more preferably about 60 μm to about 100 μm, and even more preferably about 70 μm to about 90 μm. When the total thickness of the sealant layer satisfies the above range, the resin is suppressed from flowing out during sealing, and an amount of heat and time required for the sealing may be appropriately adjusted.

### Barrier Layer

The barrier layer 20 may be configured to provide mechanical strength to the pouch, block the introduction and discharge of a gas or moisture from the outside of the secondary battery, and prevent the electrolyte from leaking.

The barrier layer 20 may have a thickness of about 40 μm to about 100 μm, more preferably about 40 μm to about 90 μm, and even more preferably about 50 μm to about 80 μm. When the thickness of the barrier layer satisfies the above range, appropriate mechanical strength and barrier properties may be realized.

The barrier layer 20 may be made of a metal material, and specifically, an aluminum alloy thin film.

The aluminum alloy thin film may include aluminum and a metal element in addition to the aluminum, for example, one or more metal elements selected from iron (Fe), copper (Cu), chromium (Cr), manganese (Mn), nickel (Ni), magnesium (Mg), or zinc (Zn).

The aluminum alloy thin film may have an iron (Fe) content of about 1.2 wt % to about 1.7 wt %, preferably about 1.3 wt % to about 1.7 wt %, and more preferably about 1.3 wt % to about 1.45 wt %. When the iron (Fe) content in the aluminum alloy thin film satisfies the above range, defects such as cracks or pinholes are less likely to be formed in the barrier layer 20, even when the cup part is deeply drawn.

### (3) Base Material Layer

The base material layer 10 may be disposed on the outermost layer of the pouch and may be configured to protect the electrode assembly from external impact and to electrically insulate the electrode assembly.

The base material layer 10 may be made of a polymer material, for example, one or more polymer materials including polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazoles, polyarylates, or Teflon.

The base material layer 10 may have a single-layer structure or, as illustrated in FIG. 2, may have a multi-layer structure in which different polymer films 12 and 14 are stacked. When the base material layer 10 has a multi-layer structure, an adhesive layer 16a may be disposed between the polymer films. In either the single-layer structure, or the multi-layer structure, the base material layer 10 may be adhered to the barrier layer 20 via an adhesive layer 16b or any other mechanism known in the art.

The base material layer 10 may have a total thickness of about 10 μm to about 60 μm, preferably about 20 μm to about 50 μm, and more preferably about 30 μm to about 50 μm. When the base material layer has the multi-layer structure, the thickness may be a thickness including the adhesive layer(s). When the base material layer 10 satisfies the above range, durability, insulation, and moldability may be excellent. When the thickness of the base material layer is too thin, the durability may be reduced, and the base material layer may be susceptible to damage during the molding process. When the thickness of the base material layer 10 is too thick, the moldability of the pouch film stack is reduced. Furthermore, as the thickness of the base material layer 10 increases, the overall thickness of the pouch may increase, which in turn, reduces the battery accommodation space and the size of the electrode assembly 200 that can be disposed therein, resulting in reducing energy density.

According to one embodiment, the base material layer 10 may have a stacked structure of a polyethylene terephthalate (PET) film (e.g., polymer film 12) and a nylon film (e.g., polymer film 14). Here, the nylon film may be disposed closest to the barrier layer 20, and the polyethylene terephthalate film may be stacked on the nylon film and disposed on an outer surface side of the pouch.

Polyethylene terephthalate (PET) material has excellent durability and electrical insulation properties, and thus, when the PET film is placed on the surface side, the durability and insulation properties may be excellent. However, PET film may not securely adhere with the aluminum alloy thin film constituting the barrier layer 20, and even when PET film is secured to the aluminum alloy thin film, the PET film may alter the stretching behavior of the pouch film stack. Consequently, during the molding process, the base material layer 10 and the barrier layer 20 may be delaminated from one another, and/or the barrier layer may be non-uniformly stretched, resulting in deterioration of the moldability of the pouch film stack. In comparison, since nylon film has a stretching behavior similar to that of the aluminum alloy thin film constituting the barrier layer 20, disposing a nylon film between the polyethylene terephthalate and the barrier layer has the effect of improving the moldability of the pouch film stack.

The polyethylene terephthalate film may have a thickness of about 5 μm to about 20 μm, preferably about 5 μm to about 15 μm, and more preferably about 7 μm to about 15 μm. The nylon film may have a thickness of about 10 μm to about 40 μm, preferably about 10 μm to about 35 μm, and more preferably about 15 μm to about 25 μm. When the thicknesses of the polyethylene terephthalate film and the nylon film satisfy the above ranges, the moldability and rigidity after the molding may be excellent.

### Lithium Secondary Battery

Next, a lithium secondary battery according to the present disclosure will be described.

The lithium secondary battery may include: an electrode assembly formed by stacking a positive electrode, a separator, and a negative electrode; an electrolyte; and a pouch-type battery case accommodating the electrode assembly and the electrolyte. Here, the battery case is the pouch described above.

More specifically, the pouch may be designed so that the sealant layer (e.g., the first sealant layer and the second sealant layer) has a melt flow rate of about 14.0 g/10 min or less, resulting in a higher sealing strength than pouches according to the related art. Therefore, when the pouch of the present disclosure is utilized to form a lithium secondary battery, the sealant layer may not be easily ruptured, even when the internal pressure of the secondary battery increases. Accordingly, the resulting secondary battery is reliable even at high-temperatures.

Specifically, the lithium secondary battery may have a cell vent resistance of about 7.7 bars or more, preferably about 7.7 bars to 15 bars, and more preferably about 8 bars to about 15 bars at a temperature of about 60° C.

In addition, the lithium secondary battery may have an accelerated high-temperature storage period of about 15 days or more, preferably about 15 days to about 30 days, and more preferably about 15 days to about 25 days, which is measured while charging up to SOC 100% under a temperature condition of about 70° C. at 1-day intervals.

Since specific details related to the pouch are the same as those described above, the remaining components except for the pouch will be described below.

FIG. 1 is a perspective view of an example lithium secondary battery including the pouch 100 and the electrode assembly 200.

### Electrode Assembly

The electrode assembly 200 may include a plurality of electrodes and a plurality of separators, which are alternately stacked. The plurality of electrodes may include a positive electrode and a negative electrode, which are alternately stacked with the separator therebetween.

The positive and negative electrodes may be prepared by applying a composition for forming an active material layer containing an electrode active material on a collector and then drying the composition.

The composition for forming a positive electrode active material layer may include a positive electrode active material, a binder, and a conductive material. The composition for forming the negative active material layer may include a negative active material, a binder, and a conductive material.

The collector is not particularly limited as long as the collector does not cause chemical change in the battery and has high conductivity. For example, the collector may be made of copper, stainless steel, aluminum, nickel, titanium, baking carbon, copper or stainless steel and may have a surface treated with carbon, nickel, titanium, silver, or an aluminum-cadmium alloy. In addition, the collector may have a thickness of about 3 μm to about 500 μm, and fine unevenness may be formed on the surface of the collector to enhance bonding strength of the active material. For example, the negative electrode collector may have various shapes such as a film, a sheet, a foil, a net, a porous body, a foam body, or a non-woven fabric.

The positive electrode active material may utilize various positive electrode active materials known in the art that are capable of causing an electrochemical reaction. Example materials, include: layered compounds such as lithium cobalt oxide (LiCOO₂) and lithium nickel oxide (LiNiO₂); lithium manganese oxide; lithium nickel oxide represented by the formula of LiNi_{1-y}M_{y}O₂ (where, M═Co, Mn, Al, Cu, Fe, Mg, B, Cr, Zn, or Ga, and includes one or more elements among the elements, 0.01≤y≤0.7); lithium nickel cobalt manganese composite oxides represented by Li_{1+z}Ni_{b}Mn_{c}Co_{1-(b+c+d)}M_{d}O₍₂₋ₑ₎Ae such as Li1+zNi1/3Co1/3Mn1/3O2 or Li_{1+z}Ni_{0.4}Mn_{0.4}Co_{0.2}O₂ (where, −0.5≤z≤0.5, 0.1≤b≤0.8, 0.1≤c≤0.8, 0≤d≤0.2, 0≤e≤0.2, b+c+d<1, M=Al, Mg, Cr, Ti, Si, or Y, and A=F, P or Cl); or olivine lithium metal phosphate represented by the formula Li₁₊ₓM_{1-y}M′_{y}PO_{4-z}X_{z} (where, M=transition metal, preferably, Fe, Mn, Co, or Ni, M′═Al, Mg, or Ti, X═F, S, or N, −0.55≤x≤+0.5, 0≤y≤0.5, and 0≤z≤0.1). The foregoing are merely examples of materials and are an exhaustive list. The positive electrode active material may be contained at an amount of about 80 wt % to about 99 wt % based on the total weight of the positive electrode active material layer.

A compound capable of reversible lithium intercalation and deintercalation may be used as the negative active material. Specific examples may include: carbonaceous materials such as artificial graphite, natural graphite, graphitized carbon fiber, and amorphous carbon; metallic compounds capable of being alloyed with lithium, such as Si, Al, Sn, Pb, Zn, Bi, In, Mg, Ga, Cd, an Si alloy, an Sn alloy, or an Al alloy; metal oxides capable of doping and undoping lithium, such as SiO_{β} (0<β<2), SnO2, vanadium oxide, and lithium vanadium oxide; or a composite including the above metallic compound and the carbonaceous material, such as a Si—C composite or a Sn—C composite, and any one or a mixture of two or more of the above-described materials may be used. Also, a metal lithium thin film may be used as the negative active material. In addition, both low crystalline carbon and high crystalline carbon may be used as the carbon material. Representatively, the low crystalline carbon may include soft carbon and hard carbon, and the high crystalline carbon may include high-temperature calcined carbon such as amorphous, platy, scaly, spherical or fibrous natural graphite or artificial graphite, kish graphite, pyrolytic carbon, mesophase pitch based carbon fiber, meso-carbon microbeads, mesophase pitches, petroleum or coal tar pitch derived cokes, and the like. The negative electrode active material may be contained at an amount of about 80 wt % to about 99 wt % based on the total weight of the negative electrode active material layer.

The binder is a component that assists bonding between the conductive material, the active material, and the collector and is typically added at an amount of about 0.1 wt % to about wt10% based on the total weight of the active material layer. Examples of the binder may include polyvinylidene fluoride (PVDF), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated EPDM, styrene-butadiene rubber, nitrile-butadiene rubber, fluorine rubber, various copolymers thereof, and the like.

The conductive material may be a component for further improving the conductivity of the active material and may be added in an amount of about 10 wt % or less, or more specifically about 5 wt % or less, based on the total weight of the active material layer. The conductive material may not be particularly limited as long as the material does not cause a chemical change in the battery and has conductivity. For example, the conductive material may include: graphite such as natural graphite and artificial graphite; carbon black such as acetylene black, Ketjenblack, channel black, furnace black, lamp black, and summer black; conductive fiber such as carbon fiber and metal fiber; metal powder such as carbon fluorine, aluminum, and nickel powder; conductive whisker such as zinc oxide and potassium titanate; conductive metal oxide such as titanium oxide; or a derivative of polyphenylene.

The separator may separate the negative electrode from the positive electrode, provide a passage for movement of lithium ions, and may be used without particular limitation as long as it is normally used as a separator in a lithium secondary battery. That is, the separator preferably has low resistance to ion movement of the electrolyte and excellent ability to absorb the electrolyte. Particularly, the separator may include a porous polymer film, for example, made of a polyolepin-based polymer such as an ethylene homopolymer, a propylene homopolymer, an ethylene/butene copolymer, an ethylene/hexene copolymer, or an ethylene/methacrylate copolymer, or at least two-layered stack structure thereof. In addition, the separator may be a typical porous non-woven fabric, for example, a non-woven fabric made of glass fiber with a high melting point, or polyethylene terephthalate fiber. In addition, an applied separator containing a ceramic component, or a polymer material, may be used to provide heat resistance or mechanical strength and may be selectively used in a single layer or multilayer structure.

The electrode assembly 200 may include a plurality of electrode tabs 230 that are welded to each other. Each of the plurality of electrode tabs 230 may be connected to a respective one of a plurality of electrodes 210 and protrude from the electrode assembly 200 to serve as a passage through which electrons move between the inside and the outside of the electrode assembly 200. The plurality of electrode tabs 230 may be disposed inside the pouch 100.

As shown in FIG. 1, the electrode tabs 230 connected to the positive electrodes and the electrode tabs 230 connected to the negative electrodes may protrude in opposite directions with respect to the electrode assembly 200. However, the present disclosure is not limited thereto. For example, the electrode tabs 230 connected to the positive electrodes and the electrode tabs 230 connected to the negative electrodes may protrude from the same side of the electrode assembly and in the same direction such that the electrode tabs 230 connected to the positive electrodes and the electrode tabs 230 connected to the negative electrodes are parallel with each other.

A lead 240 supplying electricity to the outside of the secondary battery may be connected to the plurality of electrode tabs 230 by spot welding or the like. The lead 240 may have one end connected to the plurality of electrode tabs 230 and the other end protruding to the outside of the pouch 100.

A portion of the lead 240 may be surrounded by an insulating part 250. For example, the insulating part 250 may include an insulating tape. The insulating part 250 may be disposed between the terrace 120 of the second case 102 and the terrace 120 of the first case 101, and in this state, the terraces 120 of the first and second cases may be thermally fused to each other. As a result, a portion of each of the terrace 120 of the first case 101 and a portion of the terrace 120 of the second case 102 may be thermally fused to the insulating part 250. Thus, the insulating part 250 may prevent gas generated from the electrode assembly 200 from flowing through the pouch 100 and may maintain the pouch 100 in a sealed state.

### Electrolyte

The electrolyte may be configured to move lithium ions generated by an electrochemical reaction of the electrode during charging and discharging of the secondary battery and may include an organic solvent and lithium salt.

The organic solvent may be used without particular limitation as long as it serves as a medium through which ions involved in the electrochemical reaction of the battery move. Examples of the organic solvent may include ester solvents such as methyl acetate, ethyl acetate, γ-butyrolactone, and ε-caprolactone; ether solvents such as dibutyl ether or tetrahydrofuran; ketone solvents such as cyclohexanone; aromatic hydrocarbon solvents such as benzene and fluorobenzene; carbonate solvents such as dimethyl carbonate (DMC), diethyl carbonate (DEC), ethyl methyl carbonate (EMC), ethylene carbonate (EC), and propylene carbonate (PC); alcohol solvents such as ethyl alcohol and isopropyl alcohol; nitriles such as R—CN (R is a C2 to C20 straight-chain, branched or cyclic hydrocarbon group, and may include a double-bonded aromatic ring or an ether bond); amides such as dimethylformamide; dioxolanes such as 1,3-dioxolane; or sulfolanes. Among the above examples, carbonate-based solvents are preferable, and cyclic carbonates (e.g., ethylene carbonate or propylene carbonate, etc.) having high ionic conductivity and high permittivity that may increase charging and discharging performance of the battery, and low-viscosity linear carbonate-based compounds (e.g., mixture of ethyl methyl carbonate, dimethyl carbonate, or diethyl carbonate) are preferable.

Lithium salt may be used as long as it is a compound capable of providing lithium ions used in the lithium secondary battery. Specifically, the lithium salt may include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB (C₂O₄)₂, or the like. The concentration of the lithium salt preferably may be within the range of about 0.1 M to about 5.0 M, and more preferably about 0.1 M to about 3.0 M. When the concentration of the lithium salt is within the above range, the electrolyte has appropriate conductivity and viscosity, and thus, exhibits excellent electrolyte performance, allowing the lithium ions to move effectively.

The electrolyte may further include an adhesive for the purpose of improving lifespan characteristics of the battery, suppressing a decrease in battery capacity, and improving a discharge capacity of the battery.

Hereinafter, the present disclosure will be described in more detail through a specific manufacturing example.

### Manufacturing Example

In the manufacturing example, a stacked film was prepared. The stacked film included a base material layer 10 in which a polyethylene terephthalate film layer having a thickness of about 12 μm), an adhesive layer having a thickness of about 3 μm, and a nylon film having a thickness of about 15 μm were sequentially stacked. Subsequently, a urethane adhesive was applied in a thickness of about 3 μm on the nylon film of the base layer, and an aluminum alloy thin film having thickness of about 40 μm (constituting the barrier layer 20), was stacked thereon using a dry lamination process.

Next, a sealant layer 30 including a first sealant layer 32 and a second sealant layer 34 was formed by co-extruding a maleic anhydride-modified polypropylene resin and a polypropylene resin on a surface opposite to the surface on which the base layer of the aluminum alloy thin film was stacked. During the co-extrusion process, the maleic anhydride-modified polypropylene resin layer was in direct contact with the aluminum alloy thin film, and a thickness of each of the first sealant layer and the second sealant layer was about 40 μm.

During the formation of the sealant layer, the pouch film stacks A to F (shown in Table 1 below) were manufactured by co-extrusion while controlling a resin pressure.

Afterwards, the prepared pouch film stack was cut to a size of about 50 mm×300 mm. The cut pouch film stack was put in hydrochloric acid having a concentration of about 37 wt % to melt the aluminum alloy thin film, and then, the film-shaped sealant layer was separated. Next, the separated sealant layer was sufficiently rinsed with water and dried at a temperature of about 60° C. for about 2 hours, and then rolled into a cylindrical shape to prepare a sample. The sample was then put into a melt flow rate measuring device (Gottfert MI-40) and melted at a temperature of about 230° C. for about 5 minutes, and a melt flow rate (MFR) of the sealant layer was measured while applying a load of about 2.16 kg. The measurement was performed by a melt volume rate (MVR) process, and it was assumed that a melt density of the sealant layer is about 0.728 g/cm³.

Results of the measurement are shown in Table 1 below.

TABLE 1

| | Sealant layer MFR |
|---|---|
| | (g/10 min) |
| A | 9.12 |
| B | 10.68 |
| C | 11.40 |
| D | 13.20 |
| E | 13.56 |
| F | 15.36 |

### Embodiment and Comparative Example

The resulting sealing strengths of the pouches for a secondary battery according to Embodiments 1 to 5 and Comparative Example 1 are further described below. In each of the Embodiments 1 to 5, and the Comparative Example, a pouch 100 was formed by drawings a cup part into the pouch film stacks A to F. Then, the sealant layer of each pouch prepared according to Embodiments 1 to 5 and Comparative Example 1 was sealed by thermal bonding, and a sealed portion was cut to a width of about 15 mm to prepare a sample. Then, the sealed portion of the sample was opened, and the sample was mounted on a peel strength measuring device such that a distance between the grips was about 30 mm. A T-peel test was then performed at a room temperature of about 25° C. and at a high temperature of about 60° C., at a rate of about 5 mm/min to measure the sealing strength. Here, the sealing strength was expressed as a percentage of the peel strength according to Embodiments 2 to 5 and Comparative Example 1 with respect to a reference value when the peel strength according to Embodiment 1 is defined as a reference value (100).

Results of the measurement are shown in Table 2 below.

TABLE 2

| | Pouch | Sealing strength at | Sealing strength at |
|---|---|---|---|
| | film stack | 25° C. (%) | 60° C. (%) |
| Embodiment 1 | A | 100 | 100 |
| Embodiment 2 | B | 94.7 | 100 |
| Embodiment 3 | C | 89.4 | 98.1 |
| Embodiment 4 | D | 75.2 | 93.3 |
| Embodiment 5 | E | 73.5 | 81.0 |
| Comparative | F | 38.1 | 21.0 |
| Example 1 | | | |

As shown in Table 2, the pouches of Embodiments 1 to 5 have remarkably excellent sealability at room temperature and the high temperatures compared to the Comparative Example 1.

### Experimental Example: Cell Vent Resistance of Secondary Battery and High-Temperature Acceleration Test

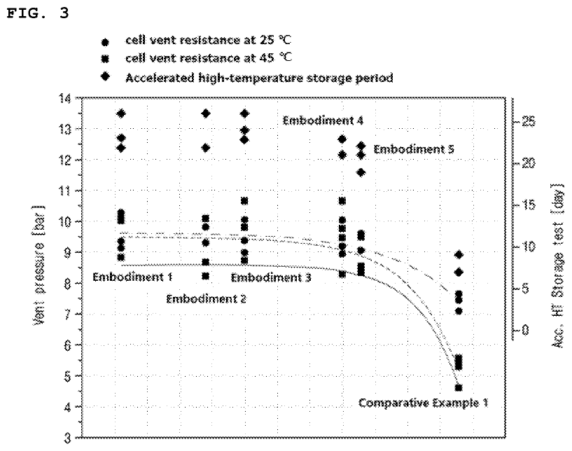

Cell vent resistance and high-temperature acceleration tests were also performed using the following method. The stack-type electrode assemblies was accommodated in the pouches for the secondary batteries prepared according to Embodiments 1 to 5 and Comparative Example 1, an electrolyte was injected, and then, the sealant layers were sealed to manufacture lithium secondary batteries. The cell vent resistance and the accelerated high-temperature storage period of each of the manufactured lithium secondary batteries were measured in the following manner. For accurate evaluation, the measurement was performed twice or three times for each lithium secondary battery, and the measurement results were shown in FIG. 3.

### (1) Cell Vent Resistance Measurement Method:

A hole of about 1 mm or less was drilled in each of the lithium secondary batteries, and an internal pressure of the cell was measured over time while injecting an inert gas at temperatures of about 25° C. and about 60° C., to calculate maximum internal pressure. The maximum internal pressure is the internal pressure of the battery when a vent occurred.

Since the cell pressure drops to atmospheric pressure when the vent is present, a point at which the cell pressure drops to the atmospheric pressure may be represented as a vent occurrence time point.

### (2) Accelerated High-Temperature Storage Period:

The lithium secondary batteries were stored at a temperature of about 70° C. and then were charged up to SOC 100% at 1-day intervals, and the storage period for which the secondary batteries were capable of being stored without venting was measured.

As illustrated in FIG. 3, in the lithium secondary batteries according to Embodiments 1 to 5, the cell vent resistance at temperatures of about 60° C. and 25° C. is higher than about 7.7 bars, and the accelerated high-temperature storage period is also higher than about 15 days. In contrast, in the lithium secondary battery according to Comparative Example 1, the cell vent resistance and the accelerated high-temperature storage period are significantly reduced at a temperature of about 60° C.

Accordingly, it can be seen that the pouch of the secondary battery according to the present disclosure, which is designed so that the sealant layer is a two-layer structure having a combined melt flow rate (MFR) of 14 g/10 min or less, has a greater sealing strength than that of the pouch according to the related art. Therefore, when lithium secondary batteries are formed using the pouch of the present disclosure, the sealant layer is not easily ruptured even when the internal pressure of the secondary battery increases. Specifically, the secondary battery may have ‘cell vent resistance’ as high as about 7.7 bars or more and may have excellent high-temperature reliability for a storage period of about 15 days or more without venting during an accelerated high-temperature storage test (accelerated high-temperature storage period).

While the present disclosure has been shown and described in connection with the exemplary embodiments, it will be apparent to those skilled in the art that modifications and variations can be made without departing from the spirit and scope as defined by the appended claims.

What is claimed is:

1. A pouch for a secondary battery, comprising:
a barrier layer;
a base material layer disposed on one surface of the barrier layer; and
a sealant layer disposed on the other surface of the barrier layer,
the sealant layer comprising:
a first sealant layer disposed directly in contact with the other surface of the barrier layer; and
a second sealant layer disposed on the first sealant layer,
the sealant layer has a melt flow rate (MFR) of about 8.5 g/10 min to about 14.0 g/10 min or less, which is measured at a temperature of about 230° C. under a load condition of about 2.16 kg, and
a total thickness of the sealant layer is in a range of about 45 μm to about 100 μm.

2. The pouch of claim 1, wherein the first sealant layer and the second sealant layer have a co-extruded structure.

3. The pouch of claim 1, wherein the first sealant layer comprises an acid-modified polyolefin resin.

4. The pouch of claim 1, wherein the second sealant layer comprises a polyolefin resin.

5. The pouch of claim 1, wherein a ratio of a thickness of the second sealant layer to a thickness of the first sealant layer is in a range of about 0.8 to about 1.2.

6. The pouch of claim 1, wherein the first sealant layer has a thickness of about 25 μm to about 80 μm, and
the second sealant layer has a thickness of about 20 μm to about 80 μm.

7. The pouch of claim 1, wherein the barrier layer comprises an aluminum alloy layer.

8. The pouch of claim 1, wherein the base material layer comprises polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazoles, polyarylates, Teflon, or a combination thereof.

9. A lithium secondary battery comprising:
an electrode assembly, in which a positive electrode, a separator, and a negative electrode are stacked;
an electrolyte; and
the pouch of claim 1,
wherein the pouch defines a cup part accommodating the electrode assembly and the electrolyte.

10. The lithium secondary battery of claim 9, wherein cell vent resistance of the lithium secondary battery is about 7.7 bars or more at a temperature of about 60° C.

11. The lithium secondary battery of claim 9, wherein an accelerated high-temperature storage period, which is measured by charging the lithium secondary battery up to SOC 100% at a temperature of about 70° C. for 1-day intervals, is about 15 days or more.

12. A method of forming a pouch for a secondary battery, the method comprising the steps of:
stacking a base material layer on a first surface of a barrier layer; and
co-extruding a sealant layer, including a first sealant layer and a second sealant layer, on a second surface of the barrier layer,
wherein the sealant layer has a melt flow rate (MFR), after the co-extruding step, of about 8.5 g/10 min to about 14.0 g/10 min or less, which is measured at a temperature of about 230° C. under a load condition of about 2.16 kg, and
wherein the sealant layer is co-extruded to have thickness in a range of about 45 μm to about 100 μm.

13. The method of claim 12, wherein after the co-extruding step, the first sealant layer is in direct contact with the barrier layer, and
the second sealant layer is stacked on a surface of the first sealant layer.

14. The method of claim 12, wherein the first sealant layer includes an acid-modified polyolefin resin, and the second sealant layer includes a polyolefin resin.

15. The method of claim 12, wherein resin pressure is controlled, using a co-extrusion device, during the co-extruding step.

16. The method of claim 15, further comprising:
replacing a filter of the co-extrusion device when the resin pressure exceeds a predetermined value.

17. The method of claim 12, wherein sealant layer is co-extruded such that the first sealant layer has a thickness of about 25 μm to about 80 μm, and the second sealant layer has a thickness of about 20 μm to about 80 μm.
